(19) United States
(12) Patent Application Publication
(10) Pub. No.: US 2022/0295773 A1
(43) Pub. Date: Sep. 22, 2022

(54) Truck Bed Holder for Fishing Rods and Methods of Using Same

(71) Applicant: John Nelson Taylor, Madison, NJ (US)

(72) Inventor: John Nelson Taylor, Madison, NJ (US)

(21) Appl. No.: 17/208,052

(22) Filed: Mar. 22, 2021

(51) Int. Cl. A01K 97/10; B60R 9/08; B60R 7/08

(52) U.S. Cl. CPC A01K 97/10; B60R 9/08; B60R 7/08

(57) ABSTRACT

Apparatus for supporting fishing rods in closed tonneau cover of pickup truck. Apparatus includes holes in front panel of tonneau cover. Each hole is angled from vertical opposite to truck cab. Plate is attached to underside of front panel and truck. Rod holders are positioned through holes in front panel so collar of rod holder rests atop front panel. Length of rod holder is disposed below front. Removable cargo bar spans width of truck bed, disposed beneath tonneau cover in front of rod holders. Removable security cable spans width of truck bed above tonneau cover securing fishing rods to truck bed. Rod holder has liner having closed bottom and open top having hinged cap to cover end of rod holder. User opens cap of tube liner to insert fishing rod into rod holder, which supports fishing rod angled at about 15 degrees from vertical opposite to truck cab.

### BACKGROUND OF THE INVENTION

Embodiments of the present invention generally relate to apparatus, systems, and methods for holding one or more fishing rods. More specifically, the present invention relates to apparatus, systems, and methods for holding one or more fishing rods in the bed of a pickup truck.

Various fishing rod holders are known for use in an open bed of a pickup truck. Such holders can include individual fishing rod holders mounted in a line across the open bed of a pickup truck.

### BRIEF SUMMARY OF THE INVENTION

With respect to a pickup truck having a truck cab positioned in front of a truck bed including a tonneau cover covering the truck bed and with the tonneau cover including a front panel adjacent to the truck cab, disclosed is an apparatus for supporting one or more fishing rods in the front panel of the tonneau cover including: 1) one or more holes in the front panel of the tonneau cover with each hole being angled in the front panel at about 15 degrees from the vertical opposite to the truck; and 2) one or more rod holders for each of the one or more holes with each rod holder including a collar about a top end of the rod holder, each of the one or more rod holders being positioned, respectively, through the one or more holes in the front panel of the tonneau cover so the collar of each rod holder rests atop the front panel, and the length of each rod holder is disposed below the front panel and angled at about the 15 degrees from the vertical opposite to the truck cab.

Also disclosed is an apparatus for supporting one or more fishing rods in a front panel of a tonneau cover of the bed of a pickup truck, including: 1) one or more holes in the front panel of the tonneau cover; and 2) one or more rod holders, respectively, for each of the one or more holes with each rod holder including a collar about a top end of the rod holder; and 3) each rod holder being positioned, respectively, through the one or more holes in the front panel of the tonneau cover so the collar of each rod holder rests atop the front panel.

Also disclosed is an apparatus for supporting one or more fishing rods in a front panel of a tonneau cover of the bed of a pickup truck, including: 1) one or more holes in the front panel of the tonneau cover with each hole being angled in the front panel at about 15 degrees from the vertical opposite to cab the pickup truck; 2) one or more rod holders, respectively, for each of the one or more holes with each rod holder including a collar about a top end of the rod holder, each rod holders being positioned, respectively, through the one or more holes in the front panel of the tonneau cover so the collar of each rod holder rests atop the front panel, and the length of each rod holders is disposed below the front panel and angled at about the 15 degrees from the vertical opposite to the cab of the pickup truck; and 3) one or more tube liners lining, respectively, inner wall of each of the one or more rod holders with each tube liner having a closed bottom end and an open top end, and with the open top end having a hinged cap selectively operable to cover and uncover the open end of the tube liner.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings, embodiments, which are presently preferred. It should be understood, however, that the invention is not limited to the precise arrangements and instrumentalities shown. In the drawings:

FIG. 1 is a rear perspective view of a truck bed holder for fishing rods in accordance with one embodiment of the present disclosure;

FIG. 2 is a cut away view of FIG. 1 in accordance with one embodiment of the present disclosure with a portion of the tonneau cover removed;

FIG. 3 is a top perspective view of a tonneau cover used with a truck bed holder for fishing rods in accordance with one embodiment of the present disclosure;

FIGS. 4A and 4B depict front and side views of a rod holder in accordance with the embodiment of the present disclosure depicted in FIGS. 1-3;

FIGS. 4C and 4D depict front and side views of a liner in accordance with the embodiment of the present disclosure depicted in FIGS. 1-3;

FIG. 4E depicts a liner assembled within a rod holder with the liner cover in the closed position;

FIG. 5 is a side cutaway view of the front panel of a tonneau cover with an installed rod holder in accordance with the embodiment of the present disclosure depicted in FIGS. 1-4;

FIG. 6 is a top view of the front panel and its adjacent panel of the tonneau cover in transparent mode to view beneath the panels, in accordance with one embodiment of the present disclosure;

FIG. 7A depicts eight installed rod holders having liners with caps in a closed position;

FIG. 7B depicts fifteen installed rod holders having liners with caps in a closed position installed in an offset, staggered configuration in accordance with an alternate embodiment of the present invention;

FIGS. 8A and 8B depict a rod holder having a drainage sleeve at its bottommost end, the drainage sleeve coupled to a drainage line in accordance with an alternate embodiment of the present invention; and

FIG. 9 depicts a rod holder with a closed bottom and internal drain in accordance with yet another alternate embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a method” may include a plurality of methods. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

Briefly stated, in one aspect of the present disclosure, the invention is an apparatus for supporting one or more fishing rods in a front panel of a tonneau cover of the bed of a pickup truck. The apparatus may be used while the tonneau cover is in a closed position, which may be desirable for reasons including, but not limited to, security, protection, and/or concealment of the contents of the truck bed from, for example, thieves, vandals, and/or weather. This apparatus provides, or is used in conjunction with, one or more holes located or created in the front panel of the tonneau cover. One or more rod holders, respectively, are provided for each of the one or more holes with each rod holder including a collar about a top end of the rod holder. Each rod holder is positioned through a respective one of the holes in the front panel of the tonneau cover, so the collar of each rod holder rests flush atop the upwardly facing surface of the front panel. Each hole may be angled in the front panel at about 15 degrees from the vertical in a direction opposite to the cab of the pickup truck. The apparatus may include one or more tube liners lining a respective inner wall of each of the one or more rod holders with each tube liner having a closed, or substantially closed, bottom end and a substantially open top end. A hinged cap may be selectively operable to cover and uncover the open end of the tube liner. The collar of each rod holder may be attached to the front panel of the tonneau cover via one or more fasteners. This apparatus also may include a plate attached to underside of the front panel of the tonneau cover and attached to the truck. In this apparatus, a cargo bar may span the inside width of the truck bed, disposed beneath the tonneau cover, and positioned in front of the one or more rod holders. The cargo bar may be removable. A security cable may be included in this apparatus spanning the exterior width of the truck bed and disposed above the tonneau cover for securing one or more of the fishing rods to the truck bed. The present invention allows the carriage of fishing rods in the bed of a truck while simultaneously allowing use of a closed tonneau cover such that the bed and/or the contents of the bed are protected from weather, theft, and the like.

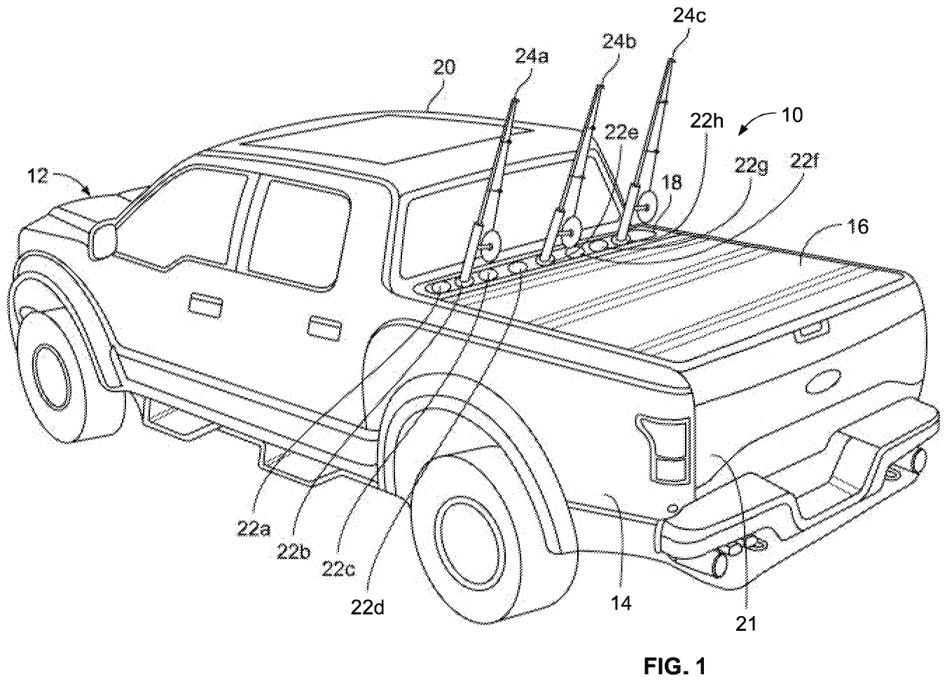

FIG. 1 illustrates an exemplary embodiment 10 of the invention, which is a truck bed holder for fishing rods. A pickup truck 12 is shown having a truck bed or bed 14. The open area above a truck bed is referred to as a tonneau. In FIG. 1, the tonneau of the truck bed 14 is covered by a tonneau cover 16. In the exemplary embodiment 10, the preferred tonneau cover 16 is a BAKFlip MX4 tonneau cover available from BAKFlip, 2303 SE 17^{th} Street, Suite 102, Ocala, Fla. 34471. Other tonneau covers may be used with the invention without departing from the scope hereof.

As seen in FIG. 1, the tonneau cover 16 spans the bed 14 of the pickup truck 12 from front to back and side to side. This covering of the truck bed 14 may be advantageous for many reasons, which may include protecting the contents of the truck bed from weather, hiding and securing the contents from theft, and improving the aerodynamics of the vehicle. The tonneau cover 16 in this embodiment of the invention 10 includes a front panel 18 that is positioned closest to the cab 20 of the pickup truck 12 with regard to other panels of the tonneau cover 16. The cab 20 of the truck also may be referred to herein as the truck cab 20. In the exemplary embodiment using the BAKFlip MX4 tonneau cover, the front panel 18 is about 4.5 inches in the direction from the front of the cab of the truck towards the tailgate of the truck 12. The front panel 18 of the tonneau cover 16 may have more rigidity than the other panels of the tonneau cover 16. This relative rigidity may be due to factors such as the fact that the front panel 18 may be shorter (from the cab to the tailgate) than the other panels, and/or that the front panel 18 may be attached in a different manner to the pickup truck 12 than the other panels of the tonneau cover 16. Other embodiments may vary. As is explained in more detail below in connection with FIG. 6, in the exemplary embodiment, a plate may be attached under the front panel 18 of the tonneau cover 16. The plate also may attach to the pickup truck 12. The purpose of the plate is to provide additional support to the front panel 18 to support the weight of the fishing rods or rods with reels.

In the exemplary embodiment 10, the front panel 18 of the tonneau cover 16 includes eight (8) openings or holes 22a-22h. Or, these holes 22a-22h may be fabricated in an existing tonneau cover 16 by a user of the apparatus. These eight openings are disposed in a generally linear fashion and are substantially equally spaced apart from each other along the width (side to side of the truck bed 14) of the front panel 18 of the tonneau cover 16. The openings 22a-22h are sized large enough to receive, respectively, the rod holders 26a-26h described below. Given that the cylindrical portions of the rod holders 26a-26h measure about two inches in diameter, the holes 22a-22h are at least two inches in at least one diameter (such as if the opening is an oval or an ellipse). Given the BAKFlip MX4 tonneau cover, the eight openings 22a-22h may be spaced at about seven inches from each other. The size of holes 22a-22h and the distance apart from each other are exemplary only and may vary in other embodiments. In the exemplary embodiment, the approximately seven inches of spacing may allow for the insertion of rods with reels in the invention. Other embodiments may include more or fewer openings and/or the openings may be arranged in a different spatial arrangement. For example, the holes may be staggered in the front panel 18 rather than being disposed in a line. The staggering of the holes or other disposition may allow for more holes than the eight included in exemplary embodiment 10.

Each of the openings 22a-22h create an open path from the top of the tonneau cover 16 into the interior of the truck bed 14. Each of the openings 22a-22h, and its respective rod holder and liner (as is explained in detail below), allows for the insertion of the handle end of a fishing rod or rod with reel. The handle end of a fishing rod or rod with reel may be inserted into one of the openings 22a-22h so the handle of the fishing rod may protrude through the top of the front panel 18 of the tonneau cover 16 into the interior of the bed 14 of the pickup truck 12.

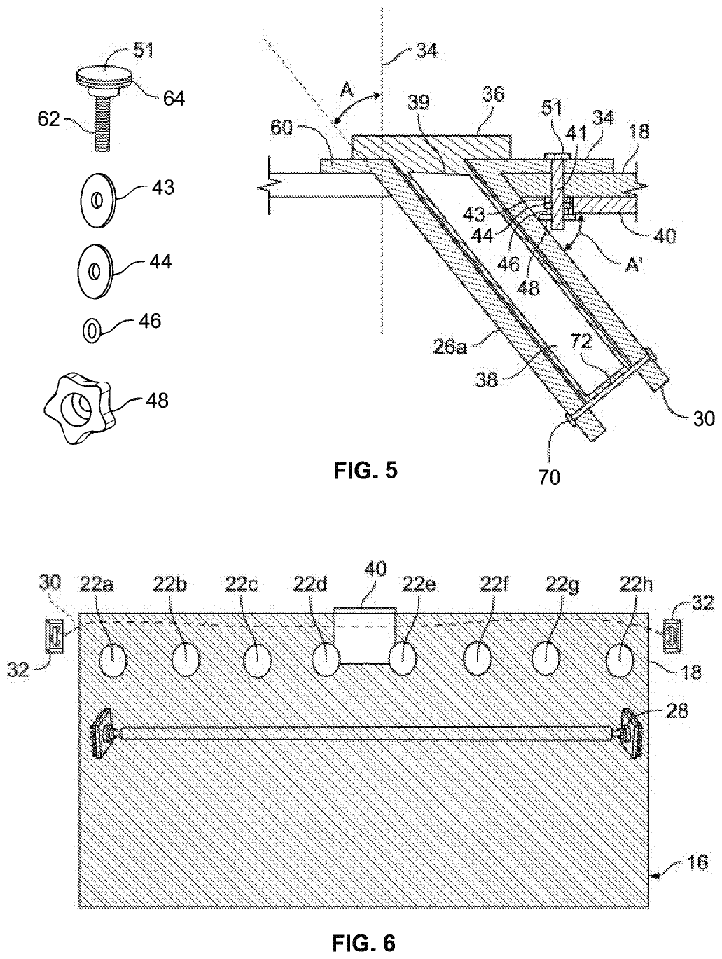

In FIGS. 1 and 2, three rods/reels 24a, 24b, and 24c are shown as inserted respectively into openings 22b, 22e, and 22h. The rods/reels 24a, 24b, and 24c are each supported by the exemplary embodiment 10 so each is disposed at an angle of about 15 degrees from the vertical and towards the back of the pickup truck 12. To achieve this 15-degree support, the openings 22b, 22e, and 22h are drilled or otherwise created through the front panel 18 of the tonneau cover 16 at about the same angle of about 15 degrees from the vertical and towards the back of the pickup truck 12 (as seen in the side view of FIG. 5). Other embodiments may offer support at an angle other than 15 degrees. Also, in the exemplary embodiment, all of the openings 22a-22h offer support at about 15 degrees from the vertical and towards the back of the pickup truck 12. However, an alternative embodiment may vary the support angles among the openings. For example, an alternative embodiment may provide alternating support angles between the openings. In other words, a first opening may offer support at the aforementioned 15 degrees and the opening next to it may offer support at about 25 degrees towards the back of the pickup truck 12. The third opening may offer the 15-degree support while the fourth opening offers the 25-degree support, and so on.

FIG. 2 illustrates the invention 10 shown in FIG. 1, but with a portion of the tonneau cover 16 cutaway so the interior 25 of the truck bed 14 may be seen with respect to the invention 10. As noted, eight openings 22a-22h are present in the front panel 18 of the tonneau cover 16. In the present invention 10, a rod holder 26a-26h is inserted into each of the openings 22a-22h in the front panel 18 of the tonneau cover 16. The rod holders 26a-26h are disposed generally below the front panel 18 of the tonneau cover 16 except for their respective collars. As shown in FIG. 2, fishing rods/reels 24a, 24b, and 24c are inserted into their respectively rod holders 26b, 26e, and 26h.

The cutaway drawing of FIG. 2 displays optional features of an embodiment of the invention 10. One optional feature is a rail 28 positioned within the interior 25 of the truck bed 14. The rail 28 may be disposed between the sides of the interior 25 of the bed 14 of the pickup truck 12 and in front of the rod holders 26a-26h. In this case, “in front of the rod holders 26a-26h” means on the other side of the rod holders 26a-26h from the back of the cab 20 of the pickup truck 12. A function of the rail 28 may be protective in that the rail 28 may block items in the bed 14 of the pickup truck 12 from encountering the rod holders 26a-26h such as in the case of a quick stop or a collision. Rail 28 may be permanently or releasably configured into its position. Rail 28 may be adjustable in its position and in other functions and features. Rail 28 also may be referred to as a truck bed cargo bar.

Another optional feature is a security lock 33 that may be used to secure one or more fishing rods to the pickup truck 12. As shown in FIG. 2, security lock 33 may include a fastener, or cable, 30 coupled to retention mechanisms 32, which act to secure cable 30 to pickup truck 12. In the depicted embodiment, retention mechanisms 32 are truck tie downs, which are often retractable. These retention mechanisms may be located along the top edge of the truck bed at the standard factory corners of the pickup truck 12. For example, fastener 30 may include two loops at either end, each of which may be padlocked to a respective retention mechanism 32 for locking the cable to the bed of the pickup truck 12. In such a scenario, before locking both ends of cable 30 to the pickup truck 12, cable 30 may be passed through one or more apertures (e.g., a harness mounting lug) on the fishing rod such that the rod may not be removed from the pickup truck 12 without removal of the security lock 33. That is, the security lock 33 locks any fishing rods inserted into one or more of rod holders 26a-26h to the bed 14 of the pickup truck 12. However, alternative systems and methods for securing fishing rods may be substituted without departing from the scope hereof. The cable 30 also may be referred to as a security cable.

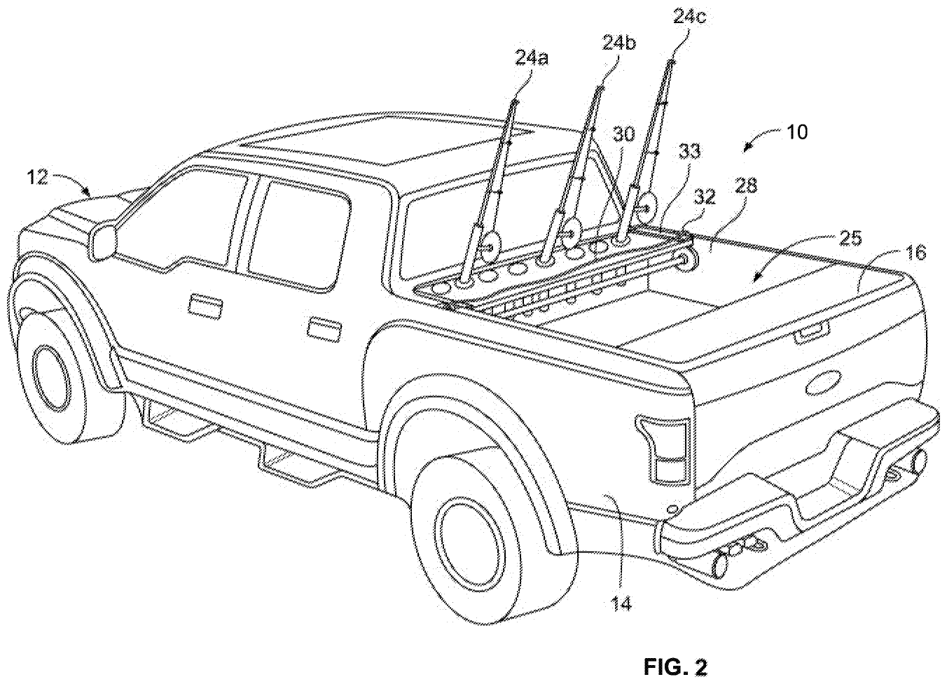

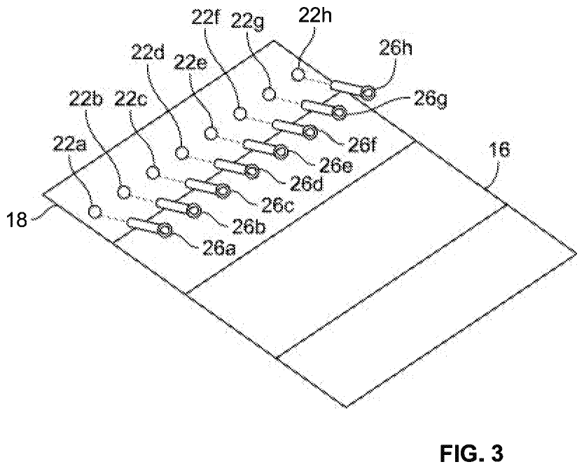

FIG. 3 illustrates a tonneau cover 16 according to the invention 10. The tonneau cover 16 includes the front panel 18 with its eight (8) holes or openings 22a-22h. Into each of the holes 22a-22h, a rod holder 26a-26h is respectively inserted as shown. In the exemplary embodiment 10, the openings 22a-22h are not made perpendicularly to the front panel 18. Rather, each of the openings 22a-22h is made at an angle of about 15 degrees with respect to the vertical. In this case, the vertical is taken as generally parallel to the back of the cab 20 of the pickup truck 12. The angle of about 15 degrees is measured from the vertical towards the tailgate 21 or back of the pickup truck 12. By having such an angle, each opening 22a-22h receives its respective rod holder 26a-26h so it is disposed about an angle of 15 degrees with respect the vertical. Thus, when a fishing rod or rod with reel is inserted into a rod holder of the invention 10, the fishing rod or rod with reel is positioned at about an angle of 15 degrees with respect to vertical.

As noted, the exemplary embodiments position its rod holders 26a-26h at an angle of about 15 degrees with respect to the vertical. Other embodiments may vary in angle. Alternatively, as noted previously, some rod holders may have a different angle than other rod holders in the same front panel of an alternative embodiment of the invention. Also, quantities other than eight may be substituted without departing from the scope of the present invention. A quantity of one or more holders may be substituted without departing from the scope hereof.

In the exemplary embodiment 10, each of the rod holders 26a-26h is a generally cylindrical tube oriented at a predetermined angle and having a collar at its topmost end. Each rod holder may be made of any appropriate material, but in the exemplary embodiment 10, each rod holder is made of stainless steel. In other embodiments, the rod holders may vary with respect to each other as to material as well as in other ways.

Each rod holder 26a-26h may have a top and a bottom. In the exemplary embodiment 10, the bottom of each rod holder is open or uncovered. By being open, the bottom of each rod holder allows for any moisture such as rainwater to drain through the bottom of the rod holder. Alternatively, the bottom of each rod holder (or one or more rod holders within an embodiment) may be covered. If a rod holder has a bottom that is covered, it may have a drain hole. The drain hole may be connected to a carry away tube for carrying away any liquid such as rainwater accumulated in the tube.

In the exemplary embodiment, the top of each rod holder is open and has a collar around the top opening. A rod holder may be inserted into the hole in the front panel of the tonneau cover with the bottom end of the rod holder leading through the hole. The collar may catch around the periphery of the hole so the rod holder may be supported from the hole into the interior of the bed of the pickup truck.

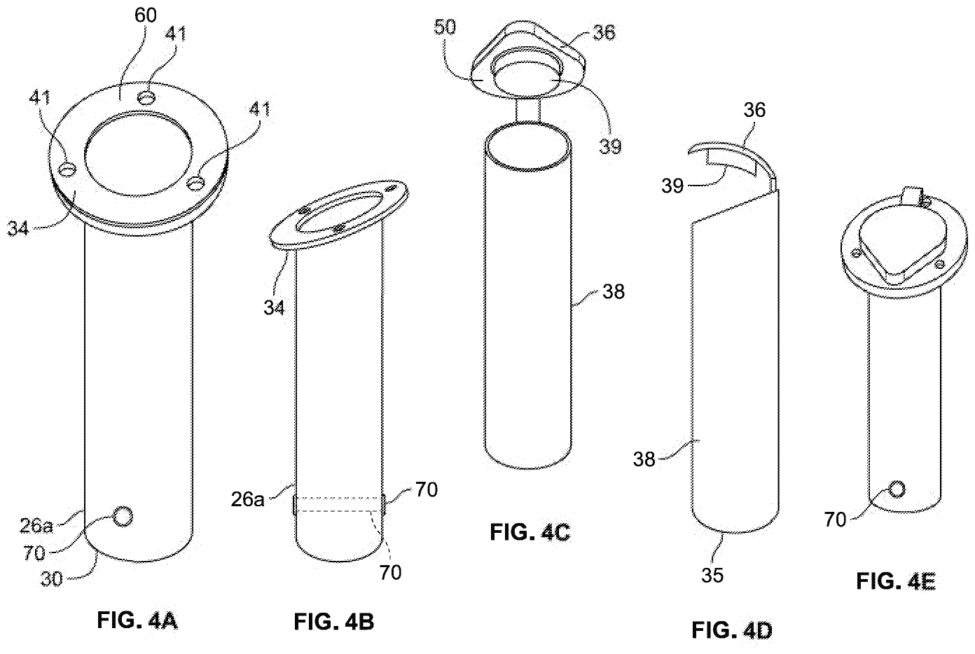

FIGS. 4A and 4B depict front and side views of an exemplary rod holder 26a shaped generally as a tube but with the top of the rod holder 26a being angled at about 15 degrees with respect to the vertical. The top of the rod holder 26a is angled at about 15 degrees so it can support a fishing rod or rod/reel at about 15 degrees to the vertical and towards the tailgate of the pickup truck 12. Other embodiments may vary. Also, other embodiments may accommodate to allow for a 15 degree (or other desired angle of support) in other ways than in the manner described here.

The top of the rod holder 26a is open with a collar 34 that encircles the top of the rod holder 26a. Given that the top of the rod holder 26a is angled at 15 degrees, the collar encircles the top at 15 degrees. The collar 34 is large enough in the exemplary embodiment to cover the top of the hole or opening 22a into which the rod holder 26a is inserted. By covering the hole 22a, the collar 34 of the rod holder 26a may prevent water or other materials from entering through the front panel 18 of the tonneau cover 16 into the interior 25 of the bed 14 of the pickup truck 12. The collar 34 may be made of any appropriate material such as the stainless steel of the rod holder 26a. The collar 34 may include openings 41 such as holes so the collar may be releasably affixed by screws or otherwise to the front panel 18 of the tonneau cover 16. Alternatively, the collar 34 may be affixed to the front panel 18 of the tonneau cover 16 in a releasable or non-releasable manner such as being affixed with hook and loop fasteners or glue to the front panel 18.

In FIGS. 4A and 4B, rod holder 26a includes an open bottom end having a substantially cylindrical stop 70 traversing the approximate midpoint of the substantially circular/cylindrical open end. Stop 70 retains a fishing pole from falling through a bottom end of rod holder 26a. The open end of rod holder 26a, and its accompanying liner 38 (also having an open end) allows the rod holders to drain water easily and to dry more quickly via evaporation or the like.

FIGS. 4C and 4D illustrate front and side views of an optional liner 38 with an attached cover 36. Liners 38 may be inserted into rod holders for holding a fishing rod therein, or the fishing rod may be inserted directly into the rod holder without use of a liner. The liner 38 is slightly smaller in circumference than the rod holder 26a so the liner 38 may fit within the rod holder 26a. The liner 38a has a closed bottom and an open top. The liner 38 fits snugly within the rod holder 26a to maximize space for holding the fishing rod or rod and reel within the rod holder 26a. As seen in FIG. 4D, to conform to the rod holder 26a, the top of the liner 38 may be cut at an angle so as not to protrude above the collar 34 of the rod holder 26a. The liner 38 slides into the rod holder 26a. In the exemplary embodiment 10, each of the rod holders 26a-26h is provided with respective liners as shown in FIG. 1. Like the rod holders 26a-26h, the liners are shaped as tubes except for their respective tops, which are angled at about 15 degrees comparable to the angles of the rod holders 26a-26h. In the depicted embodiment, the bottom end 35 of liner 38 is open to facilitate drainage and quick drying. However, alternate embodiments are envisioned in which the bottom end of the liner is closed or substantially closed. The liner 38 with attached cover 36 may be made of plastic, rubber, or any other suitable material.

In the depicted embodiment, the cover 36 of the liner 38 is attached at the highest point of the top of the liner 38, however other attachment locations may be substituted. Cover 36 includes a substantially cylindrical plug 39 coupled to its inwardly facing surface 50, which is sized to fit snugly within the top end of liner 38 and remain therein via a pressure fit. The cover 36 is large enough to cover the top of liner 38 as well as a portion of collar 34 when in its closed position as shown in FIG. 4E. The cover 36 may be attached to liner 38 by a hinge (or something comparable). The cover 36 may be large enough to effectively open and close the top of the liner 38 and thereby its exemplary rod holder 26a. When the rod holder 26a is not in use in holding a fishing rod or rod with reel, the cover 36 may be closed over the top of the rod holder 26a with plug 39 inserted into the top end of liner 38. By closing the top of the rod holder 26a, the cover may protect the rod holder 26a from accumulating water, rainwater, or other materials if the bottom of the rod holder 26a is closed, or from passing water, rainwater, or other materials into the truck bed through an open or partially open bottom of the rod holder 26a. When the rod holder 26a is to hold a fishing rod or rod with reel, the cover 36 may be opened to allow for insertion of the fishing rod or rod with reel into the rod holder 26a. The cover 36 may be made of any appropriate material such as rubber, plastic, etc.

FIG. 5 is a cutaway side view that shows the exemplary rod holder 26a as inserted into the front panel 18 of the tonneau cover 16 with the cover 36 closed. The liner 38 is shown in cutaway as it is inside the rod holder 26a. The opening 22a in the front panel 18 is made to allow the rod holder 26a to assume a position of about 15 degrees from the vertical as indicated by angle A. To allow for the rod holder 26a to assume the position of about 15 degrees from the vertical, the collar 34 of the rod holder 26a is disposed at an angle of about 15 degrees (angle A) with respect to the length of the rod holder 26a. By being angled with respect to the rod holder 26a, the collar 34 may be parallel to and lie on top of the front panel 18 of the tonneau cover 16. The cover 36 of the liner 38 is configured similarly to and is parallel with the collar 34. In other words, the cover 26 covers the top of the rod holder 26a and the cover 26 is generally parallel to and on top of the collar 34 and the front panel 18 of the tonneau cover when the cover 26 is closed over the top of the rod holder 26a. The plug 39 is inserted snugly into the top open end of liner 38.

FIG. 5 also depicts an exploded view of one exemplary attachment of a collar 36 to a tonneau cover 16. As depicted, a fastener 51 (e.g., a bolt) is passed through the top side of opening 41. In the embodiments depicted in FIGS. 4A-4E, three fasteners 51 are included to fasten each collar 36 to tonneau cover 16, however, varying quantities may be substituted without departing from the scope hereof. Thereafter, various fastening devices are passed over the shaft of fastener 51 including, but not limited to, rubber washer 43, flat stainless-steel washer 44, lock washer 46, and a 5-star finger knob 48. Knob 48 is threaded onto the shaft 62 of fastener 51 until the head 64 of fastener 51 is held tight to the upwardly facing surface 60 of collar 34, thereby fixing collar 34 tightly to the tonneau cover 16. This is just one exemplary fastening embodiment, and others may be substituted without departing from the scope hereof.

FIG. 5 also shows a plate 40 in use in the exemplary embodiment 10. The plate 40 is attached to the underside of the front panel 18 of the tonneau cover 16. The plate 40 is further described in connection with FIG. 6.

The description herein of the configuration of the rod holder 26a with respect to its opening 22a, its collar 34, and its liner 38 with cover 36 apply to the other rod holders 26b-26h of the exemplary embodiment of the invention. Nonetheless, other embodiments of the invention may configure each of the rod holders or one or more of the rod holders differently from the others with respect to the front panel 18 of the tonneau cover 16, their respective collars (if any), and their respective liners with covers (if any).

Reference now is made to the plate mentioned above that may be attached under the front panel 18 of the tonneau cover 16 in the exemplary embodiment 10. The plate also may be attached to the pickup truck 12. The purpose of the plate may be to provide additional support to the front panel 18 for the weight of the fishing rods or rods with reels when inserted into their respective rod holders.

FIG. 6 is a top-down view of part of the tonneau cover 16 including the front panel 18 with its openings 22a-22h for the rod holders 26a-26h. In FIG. 6, the front panel 18 and its adjacent panel of the tonneau cover is transparent in this illustration to allow the reader to see below the front panel 18 and its adjacent panel. Attached below the front panel 18 is a plate 40. The plate 40 may be generally rectangular in shape and may have a size that is relatively small compared to the area of the panel 18. The plate 40 may be attached in any appropriate manner to the front panel 18 such as by being bolted to the underside of the front panel 18. The plate 40 may be centered underneath the front panel 18 and may be positioned at the front side of the front panel 18, which is the side of the front panel 18 that is closest to the cab 20 of the pickup truck 12. The plate 40 may extend a bit beyond the front side of the front panel 18 so the plate 40 may be attached to the pickup truck 12. The side of the plate 40 that extends beyond the front side of the front panel 18 may hook under the lip of the truck bed adjacent to the cab 20 of the pickup truck 12. The plate may be made of any appropriate material, but in the exemplary embodiment the plate 40 is made of ⅛″ thick aluminum plating. The plate 40 may provide additional support to the front panel 18 of the tonneau cover 16 to accommodate the weight of the fishing rods or rods/reels that may be inserted into the front panel 18.

The transparent view that FIG. 6 provides of the front inside of the truck bed also shows the cable 30 that may connect one or more of the fishing rods inserted into rod holders 26a-26h to the pickup truck 12. In addition, the transparent view of FIG. 6 shows the protective rail 28 that may be disposed between the rod holders 26a-26h and the back of the pickup truck 12.

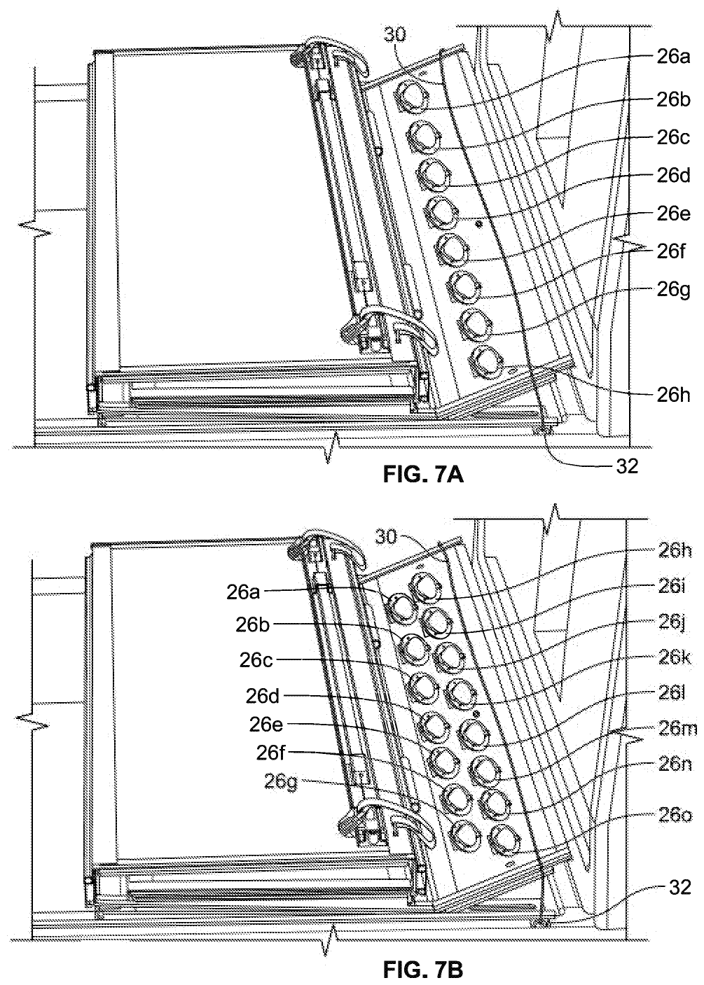

FIG. 7A depicts eight rod holders 26a-26h installed with respective liners 36, having caps 36 in a closed position. FIG. 7B depicts an alternative configuration showing fifteen rod holders 26a-26o in an offset, spaced configuration. FIGS. 7A and 7B also depict security lock 33, which may, for example, include retainer 30 coupled to retention mechanisms 32. Although one retainer 30 is shown, multiple retainers may be incorporated without departing from the scope hereof, all such retainers coupling at either end to retention mechanisms 32.

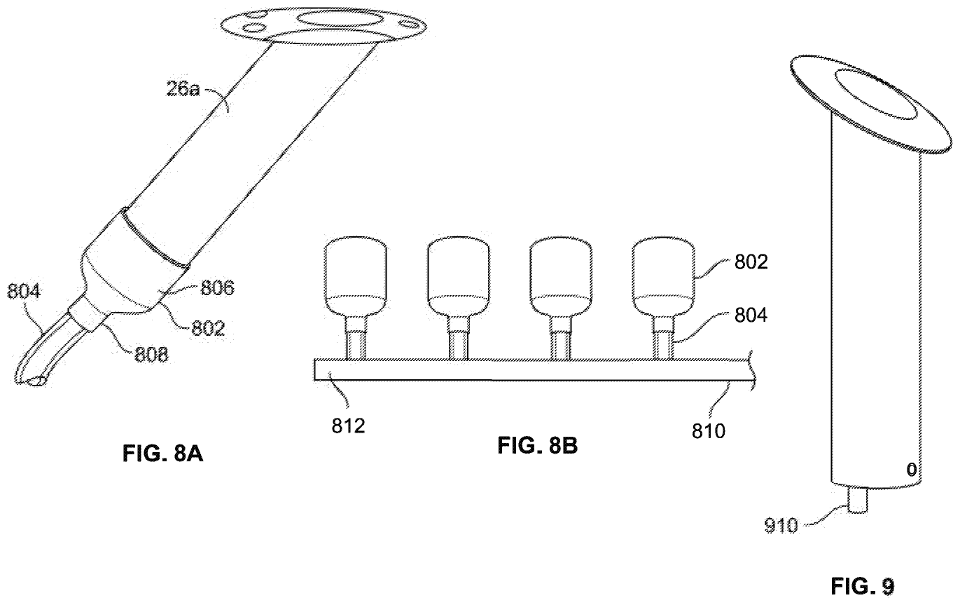

Referring now to FIGS. 8A and 8B, depicted is a rod holder 26a coupled to a drainage sleeve 802 at its bottommost end, the drainage sleeve coupled to a drainage line 804 in accordance with an alternate embodiment of the present invention. Drainage sleeve 802 and drainage line 804 may be made of rubber or similar material, and do not need to be made of the same materials. Drainage sleeve 802 has an upper end 806 that may be slid over bottommost end 30 of rod holder 26a and may be sized to fit snug thereto, thereby remaining in place due to a compression fit. Drainage sleeve 802 also has a lower end 808 sized to receive a drainage line 804, which will also be held in place via a compression fit. Drainage line 804 of a plurality of rod holders 26a may be coupled together as shown in FIG. 8B. A first closed end 812 of drainage line 804 will retain water and the like within the drainage line 804. A second open end 810 of drainage line 804 shall be run to a desirable drainage location (e.g., outside the exterior of the truck bed). However, alternate drainage mechanisms may be substituted without departing from the scope hereof.

FIG. 9 depicts yet another embodiment of a rod holder with a closed bottom and internal drain 910 in accordance with the present invention. In this embodiment, the drain is molded into the bottommost end of the rod holder and the end is otherwise closed. This configuration forces all liquids to drain to the internal drain 910. Drain 910 may drip directly into the truck bed or may also be coupled to a drainage line similar to drainage line 804 via one or more drainage sleeves 802 as discussed above with respect to FIGS. 8A and 8B (except that the drainage sleeve will have a smaller diameter/circumference to fit the smaller diameter/circumference of the internal drain 910.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. With respect to a pickup truck having a truck cab positioned in front of a truck bed including a tonneau cover covering the truck bed and with the tonneau cover including a front panel adjacent to the truck cab, an apparatus for supporting one or more fishing rods in the front panel of the tonneau cover comprising:
one or more holes in the front panel of the tonneau cover with each hole being angled in the front panel at about 15 degrees from the vertical opposite to the truck; and
one or more rod holders for each of the one or more holes with each rod holder including a collar about a top end of the rod holder, each of the one or more rod holders being positioned, respectively, through the one or more holes in the front panel of the tonneau cover so the collar of each rod holder rests atop the front panel, and the length of each rod holder is disposed below the front panel and angled at about the 15 degrees from the vertical opposite to the truck cab.

2. An apparatus according to claim 2 further comprising:
a plate attached to underside of the front panel of the tonneau cover and attached to the truck bed.

3. An apparatus according to claim 2 further comprising:
a removable cargo bar spanning the width of the truck bed, disposed beneath the tonneau cover, and positioned in front of the one or more rod holders.

4. An apparatus according to claim 2 further comprising:
a removable security cable spanning the width of the truck bed behind the removable cargo bar, and the removable security cable being disposed above the tonneau cover for securing the one or more fishing rods to the truck bed.

5. An apparatus according to claim 2 further comprising:
a tube liner lining an inner wall of each of the one or more rod holders with each tube liner having a closed bottom end and an open top end, and with the open top end having a hinged cap selectively operable to cover and uncover the open top end of the tube liner and at least part of the collar of the rod holder.

6. An apparatus for supporting one or more fishing rods in a front panel of a tonneau cover of the bed of a pickup truck, comprising:
one or more holes in the front panel of the tonneau cover;
one or more rod holders, respectively, for each of the one or more holes with each rod holder including a collar about a top end of the rod holder; and
each rod holder being positioned, respectively, through the one or more holes in the front panel of the tonneau cover so the collar of each rod holder rests atop the front panel.

7. The apparatus of claim 6 wherein with each hole is angled in the front panel at about 15 degrees from the vertical opposite to cab of the pickup truck.

8. The apparatus of claim 6, further comprising:
one or more tube liners lining, respectively, inner wall of each of the one or more rod holders with each tube liner having a closed bottom end and an open top end.

9. The apparatus of claim 8 further comprising:
a hinged cap selectively operable to cover and uncover the open end of the tube liner.

10. The apparatus of claim 6, wherein the collar of each rod holder is attached to the front panel of the tonneau cover.

11. The apparatus of claim 6, further comprising:
a plate attached to underside of the front panel of the tonneau cover and attached to the truck.

12. The apparatus of claim 6, further comprising:
a cargo bar spanning inside width of the truck bed, disposed beneath the tonneau cover, and positioned in front of the one or more rod holders.

13. The apparatus of claim 12, wherein the cargo bar is removable.

14. The apparatus of claim 6, further comprising a security cable spanning inside width of the truck bed and disposed above the tonneau cover for securing the one or more fishing rods to the truck bed.

15. The apparatus of claim 6, further comprising a security cable spanning inside width of the truck bed and disposed above the tonneau cover for securing the one or more fishing rods to the truck.

16. An apparatus for supporting one or more fishing rods in a front panel of a tonneau cover of the bed of a pickup truck, comprising:
one or more holes in the front panel of the tonneau cover with each hole being angled in the front panel at about 15 degrees from the vertical opposite to cab the pickup truck;
one or more rod holders, respectively, for each of the one or more holes with each rod holder including a collar about a top end of the rod holder, each rod holders being positioned, respectively, through the one or more holes in the front panel of the tonneau cover so the collar of each rod holder rests atop the front panel, and the length of each rod holders is disposed below the front panel and angled at about the 15 degrees from the vertical opposite to the cab of the pickup truck; and
one or more tube liners lining, respectively, inner wall of each of the one or more rod holders with each tube liner having a closed bottom end and an open top end, and with the open top end having a hinged cap selectively operable to cover and uncover the open end of the tube liner.

17. The apparatus of claim 16, wherein the collar of each rod holder is attached to the front panel of the tonneau cover.

18. The apparatus of claim 16, further comprising a plate attached to underside of the front panel of the tonneau cover and attached to the truck.

19. The apparatus of claim 16, further comprising a cargo bar spanning inside width of the truck bed, disposed beneath the tonneau cover, and positioned in front of the one or more rod holders.

20. The apparatus of claim 19, wherein the cargo bar is removable.

21. The apparatus of claim 16, further comprising a security cable spanning inside width of the truck bed and disposed above the tonneau cover for securing the one or more fishing rods to the truck.
